(19) United States
(12) Patent Application Publication
(10) Pub. No.: US 2026/0261063 A1
(43) Pub. Date: Sep. 3, 2026

(54) ELECTRICAL CONNECTION TERMINALS WITH SILVER-GRAPHITE COATING AND METHOD OF MANUFACTURE

(71) Applicant: Aptiv Technologies AG, Schaffhausen (CH)

(72) Inventors: Rene LEHMANN, Fürth (DE); Vincent REGNIER, Spardorf (DE)

(21) Appl. No.: 19/549,424

(22) Filed: Feb. 25, 2026

(30) Foreign Application Priority Data
Feb. 28, 2025 (EP) 25161103.4

(51) Int. Cl. H01R 13/03; C25D 3/12; C25D 3/46; C25D 5/12; C25D 5/48; C25D 7/06; C25D 15/00; H01R 4/58; H01R 43/00

(52) U.S. Cl. CPC H01R 13/03; C25D 3/12; C25D 3/46; C25D 5/12; C25D 5/48; C25D 7/0614; C25D 15/00; H01R 4/58; H01R 43/00

(57) ABSTRACT

An electrical connection terminal has a contact portion with a first contact area configured to establish an electrical connection with a second contact area of another connection terminal. The first contact area is at least partially coated with a nickel layer, a silver layer, and a silver-graphite layer. The silver-graphite layer is deposited selectively by electroplating over at least the first contact area, thereby providing improved electrical conductivity, tribological performance, and corrosion resistance. This configuration replaces gold-coated contact areas, particularly in low-current applications, and offers improved wear resistance and reduced maintenance requirements. The silver-graphite layer enhances the terminal's reliability and service life.

### CROSS-REFERENCE TO RELATED APPLICATION

This application claims the benefit of and priority to European Application No. 25161103.4 filed with the European Patent Office on February 28, 2025, the contents of which are incorporated by reference herein.

### TECHNICAL FIELD

The present disclosure generally relates to electrical connection terminals, and more particularly to electrical connection terminals for automotive applications having a silver-graphite coating. For example, such electrical connection terminals are used in connectors for automotive Safety Restraint Systems (SRS).

### BACKGROUND

Typically, in electrical connection terminals, the zones intended to become contact areas in the finished connection terminal include a layer of gold (possibly including other elements). Gold has exceptional properties in terms of conductivity, tribology, corrosion inertia, etc. Gold is deposited, for example, by electrochemical processes that form highly homogeneous layers. However, gold deposition processes are costly because of the price of gold, but they also have a poor record in terms of greenhouse gas production (CO₂ in particular).

For some applications, research has been conducted to replace gold with silver. However, when the silver layer deposited on the contact area of a male connection terminal comes into contact with the silver layer deposited on the contact area of a female connection terminal, a cold soldering phenomenon tends to occur (silver atoms on one side of the interface between the contact areas diffuse to the other side of this interface, and vice versa). There is then a risk of one or more layers of silver on either side of the interface being removed when the male and female connection terminals are submitted to vibrations or are moved relative to each other (when disconnecting, for example). Silver also tends to oxidize. To overcome this drawback, a thin layer of passivation is sometimes applied to the surface of the silver layer. This may not be a problem for high-current or relatively high-current applications, as the voltage across the interface is sufficient to restore conduction through a possible insulating layer. On the other hand, in other applications, for example pyrotechnic systems used in SRS applications, such as airbags, pretensioners, etc., the current involved is low and a voltage of 0.1 Volt may be insufficient to force current through this insulating layer. Furthermore, the tribological properties of silver are not as good as those of gold.

There is therefore a need to replace the layer of gold deposited on certain electrical connection terminals with a layer of another material, whose properties are similar to, equivalent to or better than gold, particularly when these connection terminals are intended for use in connectors for SRS devices.

### SUMMARY

To this end, a process for manufacturing a connection terminal and a connection terminal is described below.

More particularly, it is disclosed a process for manufacturing an electrical connection terminal (also called electrical contact). Such a terminal can be a male or a female terminal. Typically, such a terminal has an attachment portion and a contact portion. For example, the attachment portion is configured to be mechanically attached (by crimping, soldering, press-fitting) and electrically connected to another conductor (cable, wire, printed circuit, etc.). For example, the contact portion is configured to mechanically mate and electrically connect a counterpart terminal. The contact portion has a contact area configured to establish an electrical connection with a contact area of another connection terminal (i.e., the counterpart terminal). For the sake of clarity, in this document, the contact area of the connection terminal undergoing treatment according to the process described herein, is called first area. Whereas the contact area of the counterpart connection terminal is called second area.

The process includes one or more metal deposition steps over the first contact area including a deposition step of a silver-graphite layer over the first contact area.

Due to the silver-graphite layer, the first contact area has particularly suitable properties in terms of electrical conductivity, tribology, and corrosion inertia. This makes it possible to replace connection terminals with gold-coated contact areas, particularly in low-current applications (e.g. SRS applications), with connection terminals manufactured using this process. Due to the silver-graphite layer there is no need for another protective layer.

Other advantages include, for example, that the presence of a silver-graphite layer offers improved wear resistance against friction and improves the friction coefficient in comparison to pure silver, which can extend the service life of the connection terminal under mechanical switching operations and/or reduce the terminal mating forces.

This process provides a solution for depositing a silver-graphite layer on the first contact area, including in a reel-to-reel implementation. A reel-to-reel implementation allows high deposition rates, is cost-effective and is advantageous in terms of packaging and logistics.

According to an advantageous embodiment, the deposition step of a silver-graphite layer is performed by electroplating. Electroplating enables the formation of connection terminals with superior adhesion to the underlying substrate, which reduces the risk of layer delamination of the connection terminal and failure during operation. Electroplating allows for an improved corrosion resistance, wear resistance, electrical conductivity, and aesthetics. In addition, electroplating allows precise control of the thickness and composition of the deposited layer. Electroplating is highly scalable and can be easily integrated into existing manufacturing lines, resulting in high deposition rates. Electroplating results therefore in cost-effective production of high-quality connection terminals.

According to another advantageous embodiment, the deposition step of a silver-graphite layer is performed selectively (i.e. on a particular surface or surface portion of the connection terminal) over a surface including the surface of the first contact area. This reduces the amounts of materials deposited, thereby cutting costs. This also allows the material deposited to be configured to the function of the terminal portion (a contact area may require a different coating to that of a welding portion). Other embodiments are associated with other various advantages and/or technical effects.

According to an embodiment, the process includes a step of providing a sheet of metal; for example, the metal is copper or a copper alloy, one or more first forming steps applied to the sheet of metal in at least one region intended to become, in the finished connection terminal, the contact portion with the first contact area, the one or more first forming steps being chosen in the following list of operations: cutting, stamping, punching, embossing, bending, one or more metal deposition steps, subsequent to the one or more first forming steps, over at least the first contact area, including the at least one deposition step of a silver-graphite layer, one or more second forming steps, subsequent to the one or more metal deposition steps, applied to the sheet of metal in at least one region intended to become, in the finished connection terminal, a region different from the first contact area, the one or more second forming steps being chosen in the following list of operations: cutting, stamping, punching, embossing, bending.

Forming steps, and in particular those imposing high stresses on the metal sheet (for example, cutting, stamping and bending steps), particularly in the region or zone intended to become the first contact area in the finished connection terminal, can be carried out first, before the deposition of possibly fragile layers, while other forming steps necessary to complete the manufacture of the connection terminal can be carried out later, but avoiding, completely or partially, the first contact area. This has the advantage that the regions and/or zones of the connection terminal (and in particular its first contact area) where a layer of deposited material is fragile and/or brittle and/or can detach from the underlying metal (for example a layer of nickel over a copper sheet) are not subjected to stresses likely to damage them.

According to an embodiment, the one or more metal deposition steps include a deposition step of a silver layer, the at least one deposition step of a silver-graphite layer being subsequent to the deposition step of a silver layer. The advantage is that the silver layer forms a barrier (without graphite flakes) that prevents gases (e.g. oxygen) passing through the graphite flakes from reaching an underlying layer (e.g. a nickel layer) that could be corroded (e.g. by oxidation). Other advantages are, for example, the incorporation of a silver layer enhances the electrical conductivity of the connection terminal, providing a low-resistance path for electrical current; the silver layer is protected by the silver-graphite layer so as to preserve the electrical performances of the underlying silver layer; the silver layer prevents potential chemical interactions between graphite and nickel; the silver layer below the silver-graphite layer allows for a layered structure that can provide enhanced adhesion between the layers, resulting in improved mechanical integrity of the connection terminal; the silver-graphite layer prevents the silver layer from becoming black (therefore the visual aspect is better, the mating force is lower, the quality inspection with a camera in assembly line is improved, especially when the blackening is not constant and homogeneous).

According to an embodiment, the one or more metal deposition steps includes a deposition step of a nickel layer, the at least one deposition step of a silver layer being subsequent to the deposition step of a nickel layer. The advantage is that the nickel layer forms a barrier that prevents diffusion of elements from an underlying metal (e.g., the copper of the metal sheet) to overlying layers (e.g., silver and/or silver-graphite). As the nickel layer is very hard, it improves the tribological property of the terminal: a hard underlayer is covered by a soft layer which plays the role of lubrication.

It is also disclosed an electrical connection terminal including a contact portion with a first contact area configured to establish an electrical connection with a second contact area of another connection terminal. The first contact area is at least partially coated with a nickel layer, a silver layer at least partially covering the nickel layer, and a silver-graphite layer covering at least partially the silver layer.

According to an embodiment, the silver layer is located between the nickel layer and the silver-graphite layer.

Respective advantages of the silver-graphite layer, the silver layer and the nickel layer have already been mentioned above. The deposition of the silver-graphite layer is not as costly as the deposition of a gold layer and does not generate as much greenhouse gas emission as the deposition of a gold layer.

According to an embodiment, the silver-graphite layer is a surface layer, at least over the first contact area. There is no passivation layer, protection layer, etc. over the surface layer of the silver-graphite layer.

According to an embodiment, the silver-graphite layer is between 2 and 5 µm thick. A thicker layer of silver-graphite would be more costly. A thinner layer of silver-graphite would be insufficient, for example, to resist wear which could compromise the connection terminal's reliability. Advantageously, the silver-graphite layer is a thicker layer, at least slightly thicker than the graphite flakes, so that at least some of the flakes are fully embedded in silver. Advantageously, the silver-graphite layer has a good mix of silver and graphite at the surface. The graphite improves the coefficient of friction of the silver but it should not decrease electrical performance. Consequently, the thickness of the silver-graphite layer is advantageously proportional to the size of the flakes. Advantageously, the flakes are not too small otherwise silver-graphite layer loses its lubricating effect. According to an embodiment, the silver-graphite layer includes flakes of graphite the maximum dimension of which is distributed in a range from 1 µm to 5 µm. The flake size also has an impact on the homogeneity of the electrolytic bath. The flake size has also an impact on the costs. Indeed, the larger the flakes, the thicker the silver-graphite layer (the greater the silver consumption).

According to an embodiment, the silver layer is between 0.1 and 1 µm thick (preferentially between 0.1 and 0.5 µm thick). A thicker layer of silver would be more costly. A thinner layer of silver would be insufficient, for example, to prevent the gas diffusion to a possible underlying layer.

According to an embodiment, the nickel layer is between 1 and 3 µm thick. A thicker layer of nickel would be more costly. A thinner layer of nickel would be insufficient, for example, to form an efficient barrier for preventing the migration of elements (e.g., copper atoms) to overlying layer(s).

According to an embodiment, the connection terminal is a female terminal, and the contact portion is made of copper or a copper alloy. Copper has the right mechanical and electrical properties to make connection terminals of excellent quality. However, other conductive materials can be used to form the connection terminal (e.g., aluminium, aluminium alloy, iron alloy, etc.). According to another embodiment, the connection terminal is a male terminal, and the contact portion is made of a nickel-iron alloy (e.g. NiFe45 or NiFe47), steel, etc.

According to an embodiment, the graphite in the silver-graphite layer has a weight percentage relative to the silver included between 0.5 % and 2 %. In this range of percentages, there is enough graphite for the silver-graphite layer to have a self-lubricating effect (i.e., the graphite reduces the coefficient of friction), without increasing, or without significantly increasing, the contact resistance.

According to an embodiment, the graphite is evenly distributed in the silver-graphite layer. A relatively high-volume percentage of graphite evenly distributed in the silver matrix ensures that the connection terminal benefits from the self-lubricating properties of graphite evenly throughout the layer, reducing the likelihood of hot spots and improving the connection terminal's performance in particular under high-load conditions.

To summarise, this document presents solutions that eliminate (or reduce) the use of gold while maintaining or enhancing durability and reliability of electrical connection terminals. More generally, considering any type of connection terminals, the silver-graphite layer can lead to a reduction in maintenance requirements and replacement costs, as the connection terminal will retain its functionality for a longer period.

### BRIEF DESCRIPTION OF THE DRAWINGS

The present disclosure is illustrated by way of example and not limited in the accompanying figures in which like reference numerals indicate similar elements. Embodiments of the application will now be described with reference to the attached drawings:

FIG. 1 is an isometric view of a pair of male connection terminals, in the course of manufacture and still attached to each other according to some embodiments.

FIG. 2 is a top view of three female connection terminals, in the course of manufacture and still attached to each other according to some embodiments.

FIG. 3 is an isometric view of the three female connection terminals of FIG. 2, at a manufacturing stage prior to that corresponding to FIG. 2, with an enlargement of the contact blades according to some embodiments.

FIG. 4 is a process flow diagram of certain steps in a process for manufacturing a connection terminal according to some embodiments.

FIG. 5 illustrates certain steps in a process for manufacturing a connection terminal according to some embodiments.

FIG. 6 shows a scanning electron microscope image of a section in an example of nickel, silver and silver-graphite layers deposited on a copper connection terminal according to some embodiments.

### DETAILED DESCRIPTION

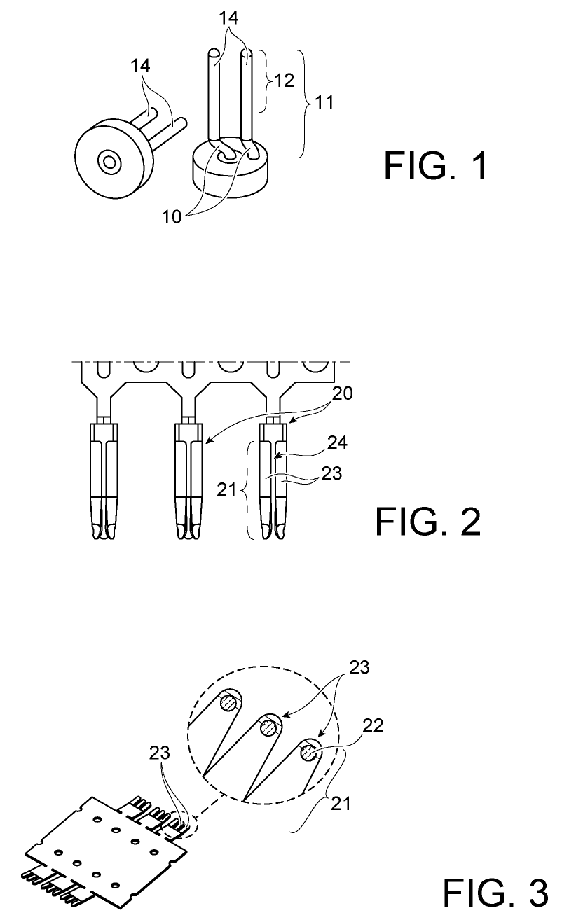

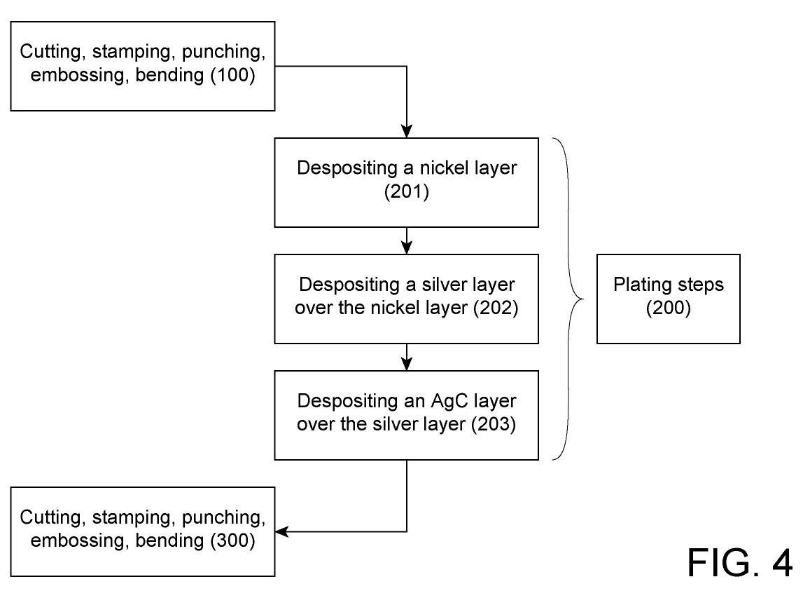

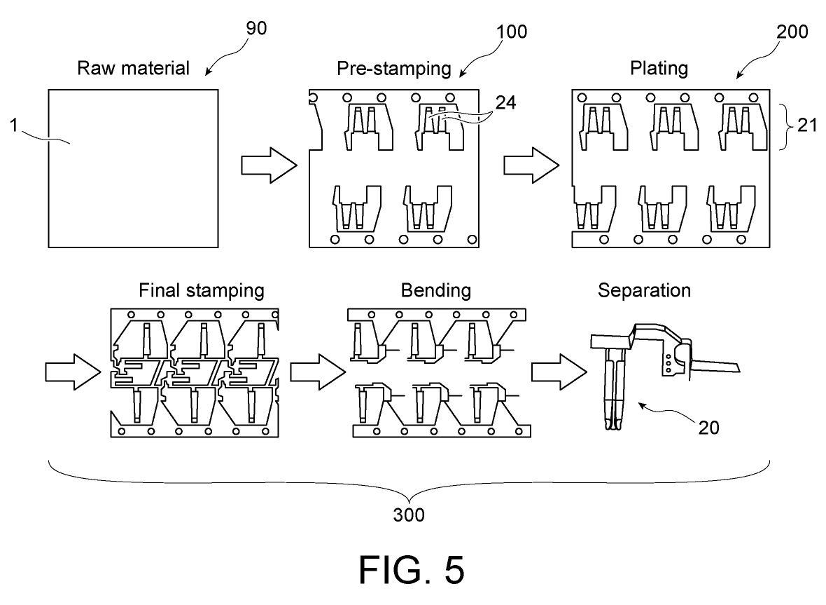

A non-limiting example of a male connection terminal 10 and a non-limiting example of a female connection terminal 20 are described below. By way of example, FIG. 1 shows a male connection terminal 10 during its manufacturing process. More specifically, FIG. 1 shows two male connection terminals 10 still linked together (they will be separated from each other at a later stage in the manufacturing process). Each male connection terminal 10 has a pin portion 14 with a contact portion 11. The contact portion 11 includes a contact area 12 configured to establish an electrical connection with a contact area 22 of a female connection terminal 20. An example of such a female connection terminal 20 is shown in FIG. 2 and FIG. 3. More specifically, FIG. 2 shows three female connection terminals 20 still linked together (they will be separated from each other at a later stage in the manufacturing process). According to this example, each female connection terminal 20 has a contact portion 21. Each contact portion 21 includes three elastic blades 23, towards the free end of each of which there is a contact area 22. For example, each elastic blade 23 is deformed at its free end to form a curved contact area 22, and more specifically so as to form a radially protruding zone towards the inside of a cage 24 formed, in the finished connection terminal, by the three blades 23, this cage 24 being configured to receive the contact portion 11 of a male connection terminal 10. The number of blades 23, the shape of the blades 23, the shape of the contact areas 12, 22, the shape of the male 10 and female 20 connection terminals themselves, etc. are not limited to the examples shown in the figures. In essence, any type of connection terminal can be manufactured using a process similar to the manufacturing process, and variants thereof, as described herein.

A non-limiting example of a process for manufacturing a female connection terminal 20 is described below, but it is essentially equivalent to a process for manufacturing a male connection terminal 10, as regards the main forming 100, 300 and electroplating 200 steps.

A step 90 of providing a sheet of metal 1. In the example of embodiment of the manufacturing process, the sheet of metal 1 is a sheet of copper. In this example, the sheet of metal 1 is a raw material (i.e., it is not already plated, for example, but in variants, the sheet of metal 1 may have undergone one or more treatments such as plating).

One or more first forming steps 100 applied in at least one region of the sheet of metal 1. In the embodiment of the manufacturing process, such a region corresponds to the contact portion 21, and more particularly, first forming steps 100 are applied to the area of the contact portion 21 intended to become, in the finished connection terminal, the blades 23 and their respective contact areas 22. The first forming steps 100 include, for example, at least one operation such as cutting, pre-stamping, punching, embossing and bending, so as to form the blades 23 and their respective contact areas 22.

One or more metal deposition or plating steps 200, subsequent to the one or more first forming steps 100. In the embodiment example of the manufacturing process, the metal deposition steps 200 include successively the electrodeposition 201 of a nickel layer A, the electrodeposition 202 of a silver layer B and the electrodeposition 203 of a silver-graphite layer C. Of course, other steps (e.g., cleaning, rinsing, drying, etc.) can be carried out before or after the electrodeposition of each layer A, B, C. The metal deposition steps 200 are performed over at least the contact areas 22. More particularly, for example, the metal deposition steps 200 can be limited to the end of the blades 23 including the contact area 22 or can cover the whole length of the blades 23.

One or more second forming steps 300, subsequent to the one or more metal deposition steps 200. The second forming steps 300 include, for example, at least one operation such as cutting, stamping, punching, embossing, bending, separating, so as to form in particular the cage 24. The second forming steps 300 are applied to the sheet of metal 1 in at least one region intended to become, in the finished connection terminal 20, a region different from the contact area 22.

The first 100 and second 300 forming steps are of a kind that is well-known to those skilled in the art of manufacturing connection terminals.

The metal deposition steps 200 are advantageously performed by electroplating techniques, in electrolytic baths.

First a nickel layer A is formed on a portion of the copper connection terminals 20 (10). For example, the nickel bath used is a product marketed by Umicore under the name NIRUNA 800. For example, a nickel layer A of 1 to 3 µm is formed by passing the end of the blades 23 (or the end of the pin portions 14), through this bath for 1.5 to 2 minutes, with appropriate current and temperature parameters.

Second, a silver layer B is deposited over the nickel layer A. For example, the silver bath is a product marketed by Umicore. For example, a silver layer B of 0.5 to 1 µm is formed by passing the end of the blades 23 (or the end of the pin portions 14), through this bath with appropriate time, current and temperature parameters.

Third, a silver-graphite layer C is deposited over the silver layer B. For example, the silver-graphite bath is a silver-graphite dispersion electrolyte marketed by Umicore under the name of ARGUNA® C-100. For example, a silver-graphite layer C of 1 to 5 µm is formed by passing the end of the blades 23 (or the end of the pin portions 14), through this bath with appropriate time, current and temperature parameters.

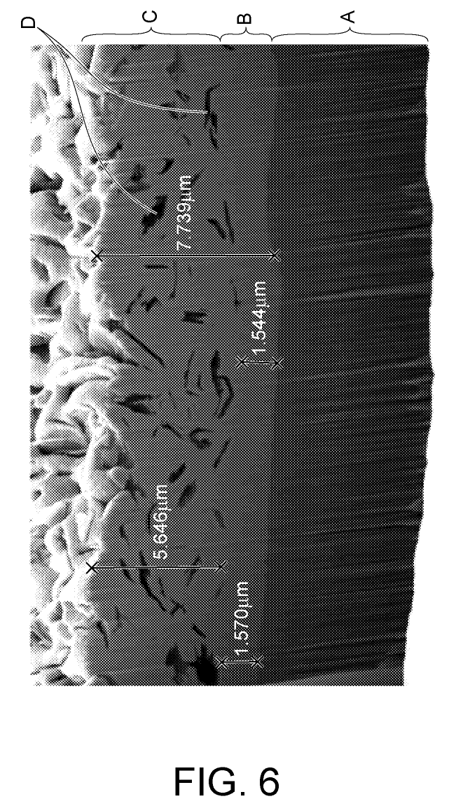

An example of a multilayer obtained with the above process is shown in FIG. 6. For example, the nickel layer A (not shown) is about 1.6µm thick, the silver layer B is about 1.5 µm thick and the silver-graphite layer C is about 5.6 µm thick. The silver-graphite layer C includes flakes of graphite D the maximum dimension of which is about 5 µm thick. The flakes of graphite D are uniformly distributed in the silver-graphite layer C.

While the invention has been described with reference to an exemplary embodiments, it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiments, but that the invention will include all embodiments falling within the scope of the appended claims.

As used herein, ‘one or more’ includes a function being performed by one element or by more than one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of order or orientation, unless stated otherwise, are used for purposes distinguishing one element from another, and do not denote any particular order, order of operations, direction or orientation unless stated otherwise.

What is claimed is:

1. An electrical connection terminal, comprising:
a contact portion with a first contact area configured to establish an electrical connection with a second contact area of another connection terminal, wherein the first contact area is at least partially coated with a nickel layer, a silver layer at least partially covering at least the nickel layer, and a silver-graphite layer covering at least partially the silver layer.

2. The connection terminal according to claim 1, wherein the silver layer is situated between the nickel layer and the silver-graphite layer.

3. The connection terminal according to claim 1, wherein the silver-graphite layer is a surface layer, at least over the first contact area.

4. The connection terminal according to claim 1, wherein the silver-graphite layer is between 2 and 5 µm thick.

5. The connection terminal according to claim 1, wherein the silver layer is between 0.1 and 1 µm thick.

6. The connection terminal according to claim 1, wherein the nickel layer is between 1 and 3 µm thick.

7. The connection terminal according to claim 1, wherein the connection terminal is a female terminal and wherein the contact portion is made of copper or a copper alloy.

8. The connection terminal according to claim 1, wherein the connection terminal is a male terminal and wherein the contact portion is made of a nickel-iron alloy.

9. The connection terminal according to claim 1, wherein graphite in the silver-graphite layer has a weight percentage relative to the silver comprised between 0.5 % and 2 %.

10. The connection terminal according to claim 1, wherein the silver-graphite layer comprises flakes of graphite having a maximum dimension in a range from 1 µm to 5 µm.

11. A process for manufacturing an electrical connection terminal comprising a contact portion, with a first contact area configured to establish an electrical connection with a second contact area of another connection terminal, the process comprising:
one or more metal deposition steps over the first contact area, wherein the one or more metal deposition steps comprise a deposition step of a silver-graphite layer selectively conducted by electroplating over at least the first contact area.

12. The process of claim 11, further comprising:
providing a sheet of metal;
a first step of forming the sheet of metal in at least one region intended to become, in a finished connection terminal, the contact portion with the first contact area;
subsequent to the forming step, depositing a silver-graphite layer over at least the first contact area; and
subsequent to the depositing step, a second step of forming the sheet of metal in at least one region intended to become, in the finished connection terminal, a region different from the first contact area, the first and second forming steps being selected from a list of operations consisting of cutting, stamping, punching, embossing, and bending.

13. The process according to claim 12, wherein the depositing step comprises a deposition step of a silver layer, wherein the process further comprises depositing a silver-graphite layer subsequent to deposition of the silver layer.

14. The process according to claim 12, wherein the depositing step comprises a deposition step of a nickel layer, the deposition step of a silver layer being subsequent to deposition of the nickel layer.
